(19) United States
(12) Patent Application Publication
(10) Pub. No.: US 2003/0118015 A1
(43) Pub. Date: Jun. 26, 2003

(54) Location based notification of wlan availability via wireless communication network

(76) Inventors: Magnus Gunnarsson, San Diego, CA (US); Sven Anders Borje Svensson, San Diego, CA (US)

Correspondence Address: COATS & BENNETT, PLLC, P O BOX 5, RALEIGH, NC, 27602, US

(21) Appl. No.: 10/027,322

(22) Filed: Dec. 20, 2001

(51) Int. Cl. H04L 12/28

(52) U.S. Cl. 370/389; 370/401

(57) ABSTRACT

A wireless mobile terminal is alerted to the presence of an available Wireless Local Area Network by a communication network, based on the location of the mobile terminal. The mobile terminal alerts a wireless computing device, either via a wired or wireless interface, or by paging the user. Alternatively, the mobile terminal and the wireless computing device may form an integrated unit with interfaces to both the WLAN and the communication network. The wireless computing device initiates a scan for the WLAN, or logs onto the WLAN based on information transmitted to the mobile terminal. When the user is not in the range of a WLAN, the wireless computing device conserves battery power by not scanning for a WLAN. The communication network may additionally be connected to the WLAN for data exchange. The alert criteria may be customized and stored in a subscriber database at the communication network.

### BACKGROUND OF THE INVENTION

The present invention relates generally to the field of wireless communications and computing, and specifically to a method of notifying a mobile terminal of the availability of a wireless local area network through a communications network, based on the location of the mobile unit.

Wireless access to communications and information services is a recent and growing trend in the telecommunications and data processing industries. Wireless communications services, such as cellular telephone services, have become ubiquitous and are today used to get wide area access to computer networks such as the Internet. Wireless local access to computer networks are also becoming commonplace, particularly in areas frequented by travelers, such as airport lounges, coffee shops, hotels, and the like. Concurrently, the line between consumer communications devices such as pagers and cellular telephones, and data processing devices such as laptop computers, continue to blur as each incorporates functionality of the other.

Due primarily to the different bandwidth needs between communications and computing devices, different wireless networks are built and deployed by service providers to address each application. Typically, wireless communication networks span large geographic regions, while wireless computing networks are more limited in geographic extent. Additionally, wireless computing networks are far less extensively deployed than are wireless communications networks in these limited areas. Thus, a number of wireless local access networks are typically subsumed within the coverage area of one or more wireless communications networks.

Wireless consumer electronics devices—both communications and computing devices—are nearly synonymous with battery-powered mobile devices. The minimization of power dissipation and the maximization of battery life are prime concerns. Many mobile consumer computing devices currently must either continuously search for a wireless local access network, wasting battery power, or alternatively the user may forego the advantages of the wireless local access network if the user is not aware of its presence and availability.

### SUMMARY OF THE INVENTION

The present invention includes a method of alerting a mobile terminal connected to a wireless communication network of the availability of a wireless local area network. The method comprises determining the location of the mobile terminal; comparing that location with the known location of the wireless local area network; and notifying the mobile terminal of the wireless local area network via the wireless communication network in response to the comparison. The notification may include transferring data regarding the wireless local area network to the mobile terminal.

The present invention additionally includes a method of a mobile unit accessing a wireless local area network. The method comprises connecting to a wireless communication network operative to determine the location of the mobile unit; receiving from the wireless communication network, in response to the location determination, a notification of the availability of a wireless local area network; and accessing the wireless local area network in response to the notification. The mobile unit may include at least a communication device and a computing device. The two devices may be integrated into a common unit, or may be separate and connected in a data transfer relationship. The data may be transferred between the communication and computing devices via a wired connection such as a wire or optical cable or a wireless connection such as an infrared data link or a BLUETOOTH interface.

### BRIEF DESCRIPTION OF DRAWINGS

FIG. 1 is a diagram depicting a wireless communications network and wireless local area networks;

FIG. 2 is a diagram depicting the lines of communication between the networks and separate wireless user devices;

FIG. 3 is a diagram depicting the lines of communication between the networks and wireless user devices connected by a data transfer interface;

FIG. 4 is a diagram depicting the lines of communication between the networks and integrated wireless user devices; and

FIG. 5 is a flowchart depicting the method step according to one embodiment of the present invention.

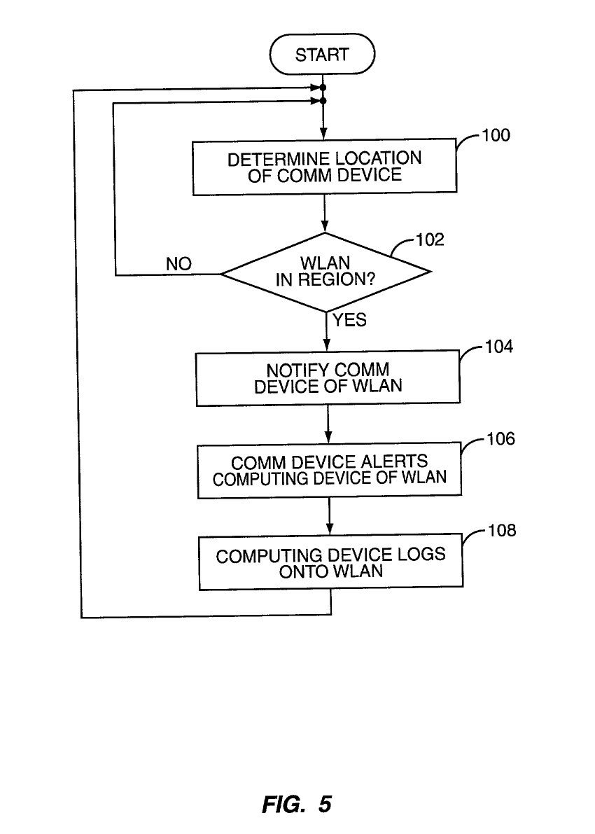

### DETAILED DESCRIPTION OF THE INVENTION

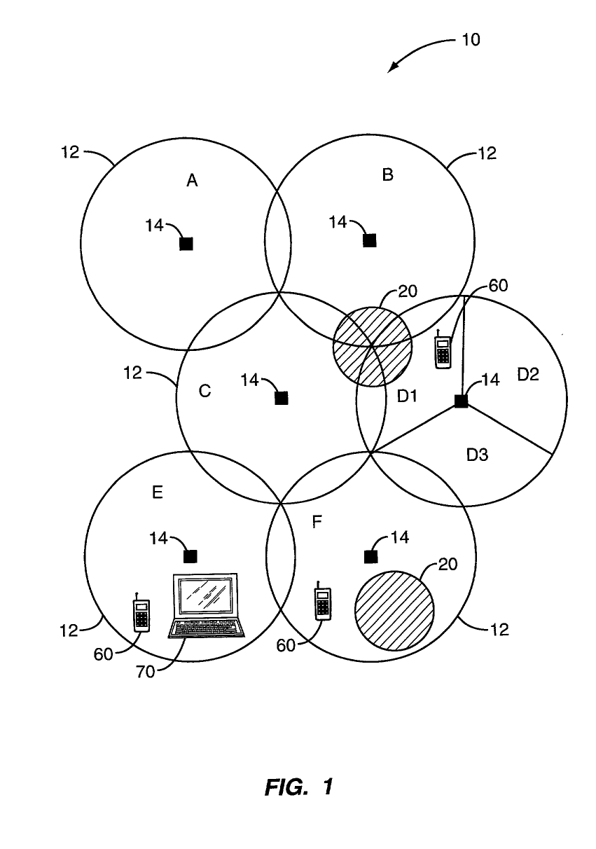

FIG. 1 depicts a wireless communication network, indicated generally by the numeral 10, providing wireless communication services to mobile terminals 60 over a large geographic area. The service area is divided into a plurality of regions or “cells” 12. A cell 12 may be subdivided into sectors two or more sectors. Each cell 12 typically includes a base station 14 for communicating with mobile terminals 60 within that cell 12. As used herein, the term “mobile terminal” means any device capable of wireless communications, and may include a cellular radiotelephone; a Personal Digital Assistant (PDA) that combines a cellular radiotelephone with data processing capabilities; or a conventional laptop and/or palmtop computer including a radiotelephone transceiver. Mobile terminals may also be referred to as “pervasive computing” devices.

Wireless communication network 10 may provide voice services, data services, or both voice and data services. Numerous standards exist for wireless communication networks. Representative standards include Time Division Multiple Access (TDMA) standards such as the Telecommunications Industry Association (TIA)/Electronics Industry Alliance (EIA) standard TIA/EIA-136, or the Global System for Wireless communication (GSM), and Code Division Multiple Access (CDMA) standards such as IS-95, cdma2000, and Wideband CDMA (W-CDMA). While the present invention is explained in the context of a CDMA network and provides examples utilizing features and capabilities specific to that standard, the present invention is not thus limited, and may be implemented by one of skill in the art in a wide variety of wireless communication networks, utilizing analogous features to implement the same or similar functions.

FIG. 1 additionally depicts Wireless Local Area Networks (WLANs) 20. WLANs 20 provide wireless access to high-bandwidth data networks to appropriately equipped wireless computing devices 70. As used herein, the term “wireless computing device” means a computing device, such as a laptop computer or Personal Digital Assistant (PDA), equipped with a wireless interface for connecting wirelessly with a computer network, such as the Internet or private network, via a wireless access point. WLANs may be implemented according to a variety of protocols and technical standards, such as for example, IEEE 802.11(b) (also known as “Wi-Fi”); the short-range wireless ad hoc network developed and promulgated by Telefonaktiebolaget L. M. Ericsson, known commercially as BLUETOOTH; IEEE 802.11(a); or HiperLAN/2.

WLANs 20 are characterized by high bandwidth data communications, and have a limited service coverage area. WLANs 20 may be deployed for private use within offices, universities, laboratories, and the like, and for public use in airport lounges, coffee shops, hotels, and the like. WLANs 20 may additionally be deployed over wider areas, such as a university campus, or several city blocks. Two or more WLANs 20 may be interconnected to provide high-bandwidth data communications over a metropolitan area. The areas covered by WLANs 20 typically form islands surrounded by areas with no such service. These islands are commonly referred to as “hot spots.”

WLANs 20 may be provided by the same service provider as the wireless communication network 10. Alternatively, WLANs 20 may be provided by independent service providers, such as Wireless Internet Service Providers (WISPs) or site operators. User access to the WLANs 20 may be restricted, such as for example, by subscription with only subscribed users granted access, or open to the general public, either on a pay-per-use basis or without billing, such as to induce customers to patronize an establishment. The particulars of access to WLANs 20, and billings therefore, are not germane to the present invention and are not further discussed herein.

Users of wireless computing devices 70 may prefer to access WLANs 20 whenever possible for network connectivity, such as Internet access, and for high-bandwidth data transfers. However, the radio frequency interfaces in wireless computing devices 70 may consume a great deal of power when constantly or periodically searching for an active WLAN 20 connection, dramatically reducing battery life.

The present invention provides a method of notifying subscribers to a wireless communication network 10 of WLAN availability when the user is in the vicinity of a WLAN 20. The wireless communication network 10 tracks the current location of a mobile terminal 60 associated with the user and sends a notification to the subscriber via the mobile terminal 60 when there is a WLAN in the vicinity of the user's current location. The mobile terminal 60 may be integrated with a wireless computing device 70 to form an integrated mobile unit with two interfaces. Alternatively, the mobile terminal 60 and wireless computing device 70 may comprise two separate devices. In the latter case, the wireless computing device 70 may have a first WLAN interface (such as an IEEE 802.11(b) interface) for communicating with the WLAN 20 and a second interface (such as a BLUETOOTH radio interface) for communicating with the mobile terminal 60. If the mobile terminal 60 and wireless computing device 70 are part of an integrated mobile unit, the mobile unit may automatically activate a WLAN interface responsive to the notification from the wireless communication network 10 and begin searching for the WLAN. If the mobile terminal comprises a separate device, the mobile terminal may forward the notification from the mobile terminal 60 to the wireless computing device 70 via the second interface, which may in turn activate its WLAN interface. If there is no interface between the mobile terminal 60 and the wireless computing device 70, the user may manually activate wireless computing device 70 and/or the WLAN interface in the wireless computing device 70. The present invention allows the wireless computing device an/or WLAN interface to be placed in an inactive mode when there is no WLAN available and awakened only when the wireless computing device 70 is in the vicinity of a WLAN, thus conserving battery power.

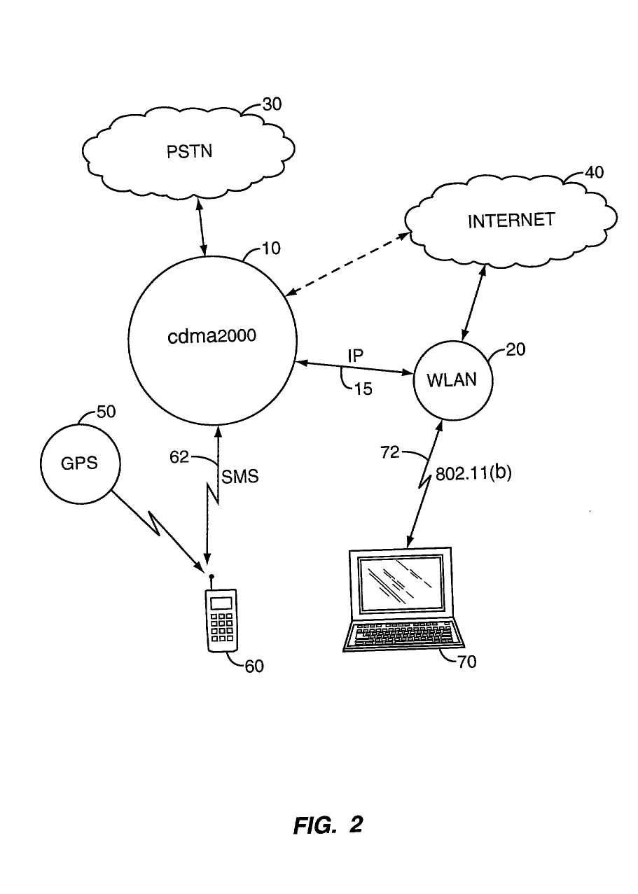

FIG. 2 illustrates an exemplary communication environment in which the present invention may be used. In FIG. 2, the user has two separate communication devices—a mobile terminal 60 for communicating with a first wireless communication network, such as a TIA/EIA/IS-2000 network 10, and a separate wireless computing device 70 for communicating with a second wireless communication network 20, such as WLAN 20. The mobile terminal 60 includes a radio interface 62, generally known as the A interface in the TIA/EIA/IS-2000 standards, for communicating with the wireless communication network 10. Wireless communication network 10 connects the mobile terminal 60 to the PSTN and may additionally connect the mobile terminal to a packet data network, such as the Internet 40. The mobile terminal 60 may further comprise a positioning receiver, such as a GPS receiver, for receiving signals from a GPS satellite 50 and determining its current location. The wireless computing device 70 includes an interface, such as an 802.11(b) compliant interface, for communicating with the WLAN 20, which serves as an access point to the Internet 40 or other packet data network. The WLAN 20 may, for example, implement the IEEE 802.11(b) protocol.

The user may be roaming within the service area of the wireless communication network 10 and may want to know when a WLAN 20 is available. To alert a user that he or she is within range of a WLAN 20 (or to directly alert the user's computing device, as described below), the wireless communication network 10 must determine the user's location, which for the purposes of the present invention may be taken as the location of the user's mobile terminal 60. In one embodiment, the location of a mobile terminal 60 may simply comprise the cell 12 within which the mobile terminal 60 is located, as indicated by the base station 14 that is serving the mobile terminal 60. For example, referring to FIG. 1, the mobile terminal 60 in a cell 12 which at least partially overlaps the coverage area of a WLAN 20 would be alerted to search for the WLAN 20, even though the mobile terminal 60 may not actually be within the coverage area of WLAN 20. For example, a mobile terminal 60 located anywhere in cell B, C, D, or F would be alerted to search for a WLAN 20, which my result in many unsuccessful searches by mobile terminals 60 within these cells but outside of the coverage area of a WLAN 20. The location of a mobile terminal 60 may be determined with greater specificity in a sectored cell, such as cell D. For example, as depicted in FIG. 1, mobile terminal 60 may only be alerted to the presence of WLAN 20 when it is being serviced within sector D1 and might not be so alerted in sectors D2 and D3. In one embodiment of the present invention, wherein the determination of the location of a mobile terminal 60 is simply an identification of the cell 12 or sector in which the mobile terminal 60 is operating, the alert transmitted by the wireless communication network 10 if a WLAN 20 is available in the cell 12 or sector (as described more fully below) may comprise a message broadcast to all mobile terminals 60 in the relevant cell 12 or sector.

While location of a mobile terminal 60 at the granularity of a cell 12 or sector allows the wireless computing device 70 to save power by not unnecessarily searching for WLANs 20 outside of a cell 12 or sector where a WLAN 20 is present, the wireless computing device 70 may still consume battery power unnecessarily searching for WLANs 20 when it is within the indicated cell 12 or sector but outside of the coverage area of the WLANs 20. A wide variety of techniques are known in the wireless communication arts for more precisely determining the location of a mobile terminal 60 within the wireless communication network 10, any of which may be advantageously applied to the present invention. For example, the relative signal strengths, signal propagation delay, phase shift, or the like of signals transmitted by the mobile terminal 60 to three or more base stations 14 may be compared to triangulate or more precisely locate the position of the mobile terminal 60. The mobile terminal 60 may include a positioning receiver and processing circuit for receiving satellite navigation signals from a satellite 50 or terrestrial antenna, and determining its position therefrom, transmitting that position information to the communication network 10. One example of such a satellite navigation system is the U.S. Global Positioning System (GPS). The mobile terminal 60 may determine its position from GPS signals independently, or alternatively, it may receive assistance data, such as satellite ephemeris data or approximate location, from the communication network 10. A wide variety of systems and methods for determining and tracking the precise location of mobile terminals 60 within a wireless communication network 10 have been developed to support location-based services such as advertising and emergency call point-of-origin reporting. These systems and methods are known in the art, and may be advantageously applied to the present invention.

Once the wireless communication network 10 has determined the location of a mobile terminal 60, that location may be compared to the known location and extent of WLANs 20. the location of the WLAN 20 may be stored in various databases and other information resources within the communication network 10. If the mobile terminal 60 is within a predetermined range of one or more WLANs 20 (for example, as measured from the center of the WLAN), the communication network 10 may notify the mobile terminal 60 of that fact via a transmission through the communication network 10. Within the predetermined range, the mobile terminal 60 may be located within the coverage area serviced by the WLAN 20 or may be approaching such coverage area. In either case, the notification is desirable to bring the wireless computing device 70 out of an inactive state, to begin searching for WLAN 20. In one embodiment, this notification may be as simple as a paging message sent to the mobile terminal 60, causing the mobile terminal 60 to signal the user, such as by emitting a predefined “beep.” Alternatively, or in addition, the wireless communication network 10 may send the mobile terminal 60 a brief text message, such as for example, “WLAN DETECTED.” The communication network 10 may send the text message to the mobile terminal 60 using a defined protocol, such as the Short Message Service (SMS), which is displayed to the user. The user may then manually enable the wireless computing device 70 to search for a WLAN 20.

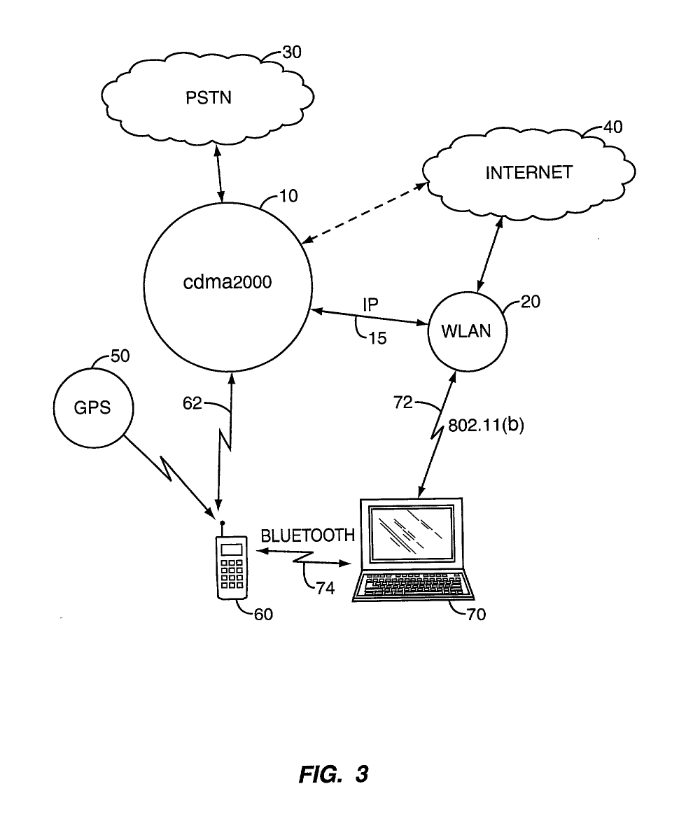

As shown in FIG. 3, both the mobile terminal 60 and wireless computing device 70 may be equipped with a second interface 74 for communicating with one another. The second interface 74 may comprise a wireless interface, such as a radio interface (e.g., BLUETOOTH interface) or infrared interface, or a wire or optical cable interface. In the embodiment of FIG. 3, the wireless communication network 10 determines the location of the user, which may comprise cell identification or ranging as described above, or may comprise receiving location information directly from the mobile terminal 60, that calculates its location from satellite signals received from the GPS system 50. If the user's location corresponds to the known service area of a WLAN 20, as stored in a database accessible to the wireless communication network 10, the network 10 sends an alert to the mobile terminal 60. This alert may include data, such as the carrier frequency of the WLAN 20, which can be sent utilizing in-band signaling within a SMS message. The signaling protocols could also be modified to enable such information to be transmitted to the mobile terminal 60 as a control message. The mobile terminal 60 may then signal the wireless computing device 70 (e.g., via a BLUETOOTH message) via interface 74, causing the wireless computing device 70 to power-up or otherwise enable its WLAN interface 72 to establish wireless data communication with the WLAN 20. The information signal sent to the mobile terminal 60 may simply indicate the availability of a WLAN 20, causing the computing device 70 to search for the WLAN 20. Alternatively, the information signal may include the carrier frequency of the WLAN 20, and/or various information such as the WLAN 20 system operator, access policies and protocols, services available, billing information, and the like. In this embodiment, the enabling of the WLAN interface 72 on the wireless computing device 70 is completely automatic with respect to the user. As the user moves into range of a WLAN 20, the wireless computing device 70 enables its WLAN interface 72 and connects to the WLAN 20. As the user moves out of the range of a WLAN 20, the wireless computing device 70 shuts down its WLAN interface 72, such as by placing the circuit(s) in “sleep” mode, thus conserving battery power and compute resources.

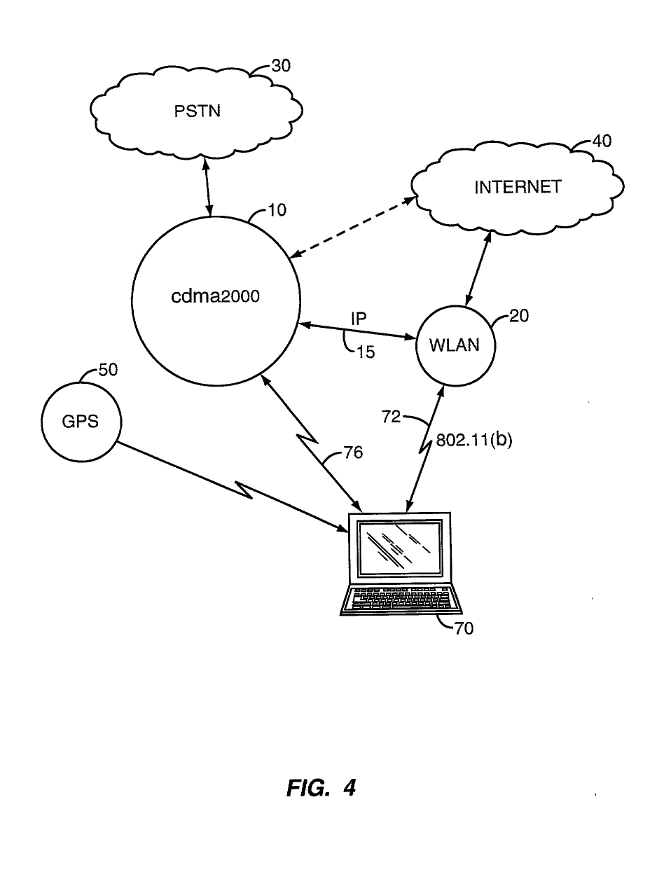

FIG. 4 shows a third exemplary embodiment of the invention. In the embodiment shown in FIG. 4, the mobile terminal 60 is integrated with the wireless computing device 70 to form an integrated mobile unit with at least two wireless interfaces 72 and 76. The first wireless interface 72 is a WLAN interface and the second interface is a TIA/EIA/IS-2000 interface. The wireless computing device 70 communicates with the WLAN 20 via the WLAN interface 72 and communicates directly with the wireless communication network 10 via the second interface 76. In this embodiment, the mobile computing device 70 may place the first wireless interface 72 in an inactive mode when it is outside the range of a WLAN 20. As the mobile computing device moves closer to a WLAN 20, the wireless communication network 10 sends a notification to the wireless computing device 70, which is received via the second interface 76. The notification may take any of the forms described above, but preferably includes information to facilitate establishing a connection with the WLAN 20. Upon receiving the notification form the wireless communication network 10, the wireless computing device 70 wakens its WLAN interface 72, begins searching for the WLAN 20, and establishes a connection if a WLAN 20 is found. Alternatively, the user may be prompted before connecting with the WLAN 20.

The manner in which the wireless communication network 10 alerts the mobile terminal 60 of the presence of WLAN 20, and the information communicated to the mobile terminal 60, may vary according to a user-specific profile, for example stored in a subscriber database in the communication network 10 such as the Home Location Register (HLR), as is well known to those of skill in the art. For example, such a database may indicate the WLAN 20 systems to which the user subscribes, or billing charges the user is willing to incur. The database may also indicate the manner in which the user's mobile terminal 60 is to be notified, which may vary among users depending on their equipment and its capacities. In this manner, each user may customize the location-based alerts to available WLAN 20, and their automatic connection thereto, along a wide variety of parameters.

In one embodiment, in addition to alerting the mobile terminal 60 of the presence of a WLAN 20 in response to the location of the mobile terminal 60, the wireless communication network 10 may communicate with the WLAN 20 directly, such as across an IP interface 15. The communication network 10 may receive data from the WLAN 20 concerning its operation, access, billing, available services, and the like for comparison to the user's preferences stored in a subscriber database, and/or for transmission to the user. The communication network 10 may also transfer information regarding the user to the WLAN 20, such as the user's identification, enabling the WLAN 20 to access the user's email or perform other data processing in anticipation of the user registering with the WLAN 20.

Those of skill in the art will readily recognize that the configuration depicted in FIGS. 2-4 is representative only. In particular, the communication network 10 may communicate with the WLAN 20 in a variety of ways, such as through an SS7 signaling network, across a dedicated T1/E1 trunk, through the Internet 40, or the like. Similarly, the link 15 between the communication network 10 and the WLAN 20 may be omitted altogether, as may be the case if the respective service providers are separate business entities with no cooperative agreement or data-sharing protocol in place. In such a case, the communication network 10 may simply alert the mobile terminal 60 to the presence of the WLAN 20, and allow the wireless computing device 70 to search for the WLAN 20 and perform all login and authentication procedures.

A flowchart depicting a method implemented in wireless communication network 10 of alerting a mobile terminal 60 or wireless computing device 70 to the presence of a WLAN 20. Initially, the wireless communication network 10 determines the location of the mobile terminal 60 or wireless computing device 70 (block 100). This may be through cell or sector identification, ranging, triangulation, or other technique as described above, or may simply comprise receiving location information from the mobile terminal 60 or wireless computing device 70, such as from a GPS receiver integrated therein. The current location of the mobile terminal 60 or wireless computing device 70 is compared with the known locations and extent of WLANs 20 to determine whether the mobile terminal 60 or wireless computing device 70 is within the proximity of, or within the coverage area of, a WLAN 20 (block 102). If not, no alert is sent, and control returns to block 100 to monitor the location of the mobile terminal 60 or wireless computing device 70. If the mobile terminal 60 or wireless computing device 70 is determined to be within a predetermined range of a WLAN 20, the wireless communication network 10 sends a notification to the mobile terminal 60 or wireless computing device 70, such as by a page, text message, in-band signaling data transfer, or the like, as described above (block 104). The response of the mobile terminal 60 or wireless computing device 70 will depend upon the configuration of the user's mobile devices. If the notification is received by a mobile terminal 60 without an interface to the wireless computing device, the mobile terminal 60 may simply alert the user by beeping, turning on an indicator, or displaying a text message on a display. If the mobile terminal 60 has an interface for communicating with a wireless computing device 70, the mobile terminal 60 may send a message to the wireless computing device 70 (block 106). The wireless computing device 70 may also receive the notification directly form the wireless communication network 10 if the wireless computing device is equipped with a network interface 76. In the latter two cases, the wireless computing device 70 may activate its WLAN interface 72, begin searching for the WLAN 20, and establish a connection with the WLAN 20 (block 108) if a WLAN 20 is found. Control then returns to block 100, where the communication network 10 continues to monitor the location of the wireless computing device 70.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of notifying a mobile terminal that a wireless local area network is present, said mobile terminal being connected to a wireless communication network, comprising:
determining the location of said mobile terminal;
comparing said location with a known location of said wireless local area network; and
notifying said mobile terminal of said wireless local area network via said wireless communication network in response to said comparison.

2. The method of claim 1 wherein notifying said mobile terminal of said wireless local area network comprises transferring data regarding said wireless local area network from said wireless communication network to said mobile terminal.

3. The method of claim 2 wherein transferring data regarding said wireless local area network comprises sending said data as a SMS message.

4. The method of claim 1 wherein determining the location of said mobile terminal comprises determining the cell of said wireless communication network in which said mobile terminal is located.

5. The method of claim 4 wherein determining the location of said mobile terminal further comprises determining the sector of said cell in which said mobile terminal is located.

6. The method of claim 1 wherein determining the location of said mobile terminal comprises processing signals received by said mobile terminal from two or more base stations to compute the location of said mobile terminal.

7. The method of claim 1 wherein determining the location of said mobile terminal comprises receiving location data from said mobile terminal.

8. The method of claim 7 wherein said location data is calculated from satellite navigation signals received at said mobile terminal.

9. The method of claim 1 wherein notifying said mobile terminal of said wireless local area network comprises broadcasting a notification of said wireless local area network over a broadcast or paging channel.

10. The method of claim 1 wherein notifying said mobile terminal of said wireless local area network comprises notifying said mobile terminal in a manner specified by an entry in a subscriber database of said wireless communication network, said entry being associated with said mobile terminal.

11. A method of operating a mobile computing device to conserve power, said mobile computing device including a first wireless interface for communicating with a first network, said method comprising:
placing said first wireless interface in an inactive mode;
receiving a notification indicating the presence of a first network proximate the current location of the mobile computing device from a second network; and
activating said first wireless interface responsive to said notification.

12. The method of claim 11 wherein said mobile computing device includes a second interface and wherein said notification is received by said mobile communication device over said second interface.

13. The mobile computing device of claim 12 wherein said second interface is a wireless communication interface for communicating directly with said second network.

14. The method of claim 12 wherein said mobile computing device uses said second wireless interface to communicate with a mobile terminal, and wherein said mobile terminal relays said notification from said second network to said mobile computing device via said second interface.

15. The method of claim 14 wherein said second interface is a short-range wireless interface.

16. The method of claim 15 wherein said second interface is an optical interface.

17. The method of claim 15 wherein said second interface is a radio frequency interface.

18. The method of claim 15 wherein said second interface is a BLUETOOTH interface.

19. The method of claim 14 wherein said second interface is a wire or an optical cable.

20. The method of claim 11 wherein said first network comprises a wireless local area network.

21. The method of claim 20 wherein said wireless local area network conforms to the IEEE 802.11(b) standard.

22. The method of claim 11 wherein said second network comprises a wireless communication network.

23. The method of claim 22 wherein said wireless communication network conforms to the TIA/EIA/IS-2000 standard.

24. A method of connecting a mobile computing device to a wireless local area network, comprising:
receiving from a mobile terminal data pertaining to the presence of said wireless local area network, said data being communicated to said mobile terminal by a wireless communication network in response to detecting a current location of said mobile terminal; and
connecting said mobile computing device to said wireless local area network in response to receiving said data.

25. The method of claim 24 further comprising activating a wireless local area network interface in said mobile computing device in response to receiving said data.

26. The method of claim 25 wherein said data is transferred from said mobile terminal to said mobile computing device over a wireless data interface.

27. A wireless communication network, comprising:
a plurality of base stations operative to communicate wirelessly with at least one mobile terminal;
a database storing location information relating to at least one wireless local area network; and
a location estimator operative to estimate the location of said mobile terminal, and to notify said mobile terminal if said mobile terminal is within a predetermined range of said wireless local area network.

28. The network of claim 27, wherein said predetermined range includes a coverage area serviced by said wireless local area network.

29. The network of claim 27, further comprising a data communications interface to said wireless local area network.

30. A wireless communication system, comprising:
a mobile terminal;
a plurality of base stations operative to communicate wirelessly with said mobile terminal;
a database storing location information relating to at least one wireless local area network;
a wireless mobile computing device including a wireless local area network interface for communicating with said wireless local area network, said interface being maintained in an inactive state and placed in an active state in response to a notification received by said mobile terminal from said wireless communication network indicating the proximity of said mobile terminal to said wireless local area network.

31. The system of claim 30 wherein said wireless mobile computing device additionally includes a data communication interface to said mobile terminal.

32. The system of claim 31 wherein said data communication interface comprises a wire or optical cable.

33. The system of claim 32 wherein said data communication interface comprises a wireless interface.

34. The system of claim 33 wherein said wireless interface is an optical interface.

35. The system of claim 34 wherein said wireless interface is a radio frequency interface.

36. The system of claim 35 wherein said wherein said radio frequency interface is a BLUETOOTH interface.
